(19) United States
(12) Patent Application Publication
(10) Pub. No.: US 2016/0318485 A1
(43) Pub. Date: Nov. 3, 2016

(54) Flat Wiper Blade for Bus

(71) Applicant: Zhifang Liu, Dongguan (CN)

(72) Inventor: Zhifang Liu, Dongguan (CN)

(21) Appl. No.: 14/811,841

(22) Filed: Jul. 29, 2015

(30) Foreign Application Priority Data
Apr. 29, 2015 (CN) 201520267160.2

(51) Int. Cl. B60S 1/40

(52) U.S. Cl. CPC B60S 1/40

(57) ABSTRACT

The present invention refers to a frameless wider blade for bus, comprising a plastic lid, an iron brush head, an elastic steel slice, a rubber back cover, a plastic wing, a stainless steel string, and a wiper strip, wherein the wiper blade comprises a plastic lid and an iron brush head connected with the wiper arm, an elastic steel slice connected with the iron brush head fixedly and the wiper strip through at least 8 small flaps to connect the structure and install fixedly, the strip is mounted on the elastic steel slice through small flaps, and the elastic steel slice is mounted on the iron brush head, the assembly of frameless wiper blade can be implemented by connecting the plastic lid and the iron brush head with the wiper arm. Or in an alternative mode, a frameless wiper blade comprises a fastener and a strip, the fastener is mounted within the elastic steel slice, wherein the strip is passing through the fasteners and others are same. The wiper blade can solve various shortcomings of existing framed wiper blade for bus effectively, which can wipe water cleaner and use safer.

### CROSS-REFERENCE TO RELATED APPLICATIONS

This application is a continuation-in-part of, and claims priority to, Chinese Patent Application No. 201520267160.2 with a filing date of Apr. 29, 2015. The content of the aforementioned application, including any intervening amendments thereto, is incorporated herein by reference.

### TECHNICAL FIELD

The present invention refers to the field of wiper blade, in particular a frameless wiper blade for bus.

### BACKGROUND OF THE PRESENT INVENTION

As FIG. 1 shown, the wiper blade for bus in the prior art comprises a large frame 101, two middle frames 102 connected with the large frame 101 separately, four small flaps 103 mounted on the two middle frames 102 and a strip with stainless steel strings mounted on the four small flaps 103, the work principle of which is to put pressure on the large frame 101 to swing by the wiper arm, and further bring the middle frame, small flap and the strip to swing to wipe water.

While there are following shortcomings of the wiper blade for bus above mentioned, the existing wiper blade for bus is longer, such as sometimes it can reach to a maximum of about 40 inches, and only 4 small flaps can be mounted with the limitation of structure, so it is easily to occur the situation that the force of the strip is uneven, and the glass and the tape does not fit tightly because there are 8 force points of the strip, resulting in the unclean wipe. Moreover, the thicker iron materials need to be used to make the frame due to the long wiper blade, which will make the wiper blade weight overweight and increase the load on motor, causing motor damage easily. Besides, the wiper arm and the fixed device of connecting rod is easily to be dislocated when the wiper blade is in work due to overweight, which will make the wiper blade drop to below the windshield, thereby it does not work normally and bring security risk to driving rain. To adapt to the glass radian area of bus, usually the rivets are needed to connect the windshield wiper, and definite gaps are often existed between iron frame and middle frame, and between middle frame and small flaps, and the gaps will become larger and larger with the extended use of time, which is easy to make the strip lie on the glass so that the wiper strip is unable to form right wiper angle (40-50 angle) with the glass and the unclean rainwater will bring security risk to driving rain.

### SUMMARY OF THE PRESENT UTILITY MODEL

Based on the work experience over years and professional knowledge, the applicant study and innovate actively to develop a frameless wiper blade for bus to solve the problems of framed wiper blade, such as uncleanness, overweight wiper, and easy to scratch the glass.

The present invention provides a frameless wiper blade, wherein the wiper blade comprises a plastic lid and an iron brush head connected with the wiper arm, an elastic steel slice connected with the iron brush head fixedly and the wiper strip mounted on the elastic steel slice fixedly through connection structure;

Further, the connection structure includes at least 8 small flaps, and the 8 small flaps are mounted on the elastic steel slice fixedly, and the wiper strip is mounted on the 8 small flaps.

Further, the elastic steel slice is circular arc shaped.

Further, the plastic lid is wrapped and mounted on the surface of the iron brush head.

Further, the elastic steel slice is connected with the iron brush head fixedly by riveting.

Further, the surface of the steel elastic surface is provided with a rubber back cover.

Further, the connection structure includes at least 16 fasteners, and the fasteners are mounted on the elastic steel slice, the wiper strip is mounted on the fasteners.

The beneficial effects of the present invention is that the wiper strip is mounted on the elastic steel slice, and the elastic steel slice is mounted on the iron brush head, and the frameless wiper blade is realized by connecting the iron brush head with the wiper arm, which can reduce the weight of wiper blade for bus effectively in the prior art and reduce the workload of wiper blade motor to increase the lifetime. Further, the force of wiper strip can be more even when working through setting at least 8 small flaps or 16 fasteners, thereby the wiper strip can fit more closely with the windshield and wipe the water cleaner. Moreover, compared with the prior art, the present frameless wiper blade abolish the whole iron frame and lower the height of the whole wiper blade through setting the elastic steel slice as circular arc shaped, so that the wiper strip can keep good wiping angle with the glass surface to wipe the water cleaner.

### BRIEF DESCRIPTION OF THE DRAWINGS

To explain the technical proposals of the present invention more clearly, the accompanying drawings need to be used in modes will be described briefly as below, obviously, the accompany drawings described as below are merely some modes of the present invention, those skilled in the art can obtain other accompany drawings under the premise that no creativity and labor is given.

FIG. 1 is a schematic diagram of frameless wiper blade for bus in the prior art.

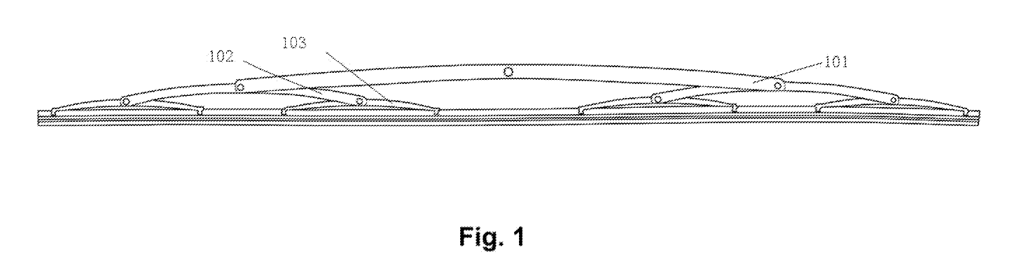

FIG. 2 is a schematic diagram of one embodiment of the frameless wiper blade for bus of the present invention.

FIG. 3 is an inner schematic diagram according to one embodiment of the frameless wiper blade for bus of the present invention.

FIG. 4 is an exploded diagram according to one embodiment of the frameless wiper blade for bus of the present invention.

FIG. 5 is schematic diagram according to another embodiment of the frameless wiper blade for bus of the present invention.

FIG. 6 is an inner schematic diagram of FIG. 5.

### DETAILED DESCRIPTION OF THE PRESENT INVENTION

To explain the present invention more clearly, the present invention will be further described as below with reference to the accompanying drawings. Obviously, the described embodiments merely show several specific embodiments of the present invention, and the present invention is not limited thereto. Any embodiments based on the present embodiments that may come into the mind of those skilled in the art s under the premise that no creativity and labor is given shall fall into the protection scope of the present invention.

In the description of the present invention, it should be understood that the term “up”, “down”, “inside”, “outside” and other words of location or position are based on the direction or position indicated in accompany drawings, it is merely to describe the present invention conveniently and simply, rather than to indicate or imply that the devices or members must have specific direction and structure and operate with specific direction, so the present invention is not limited thereto. Besides, the use of term “the first”, “the second” and other words are merely for the discrimination of indicated members, and it is not relation of primary and secondary, so the present invention is not limited thereto.

The present invention will be further described as below with reference to the accompanying drawings.

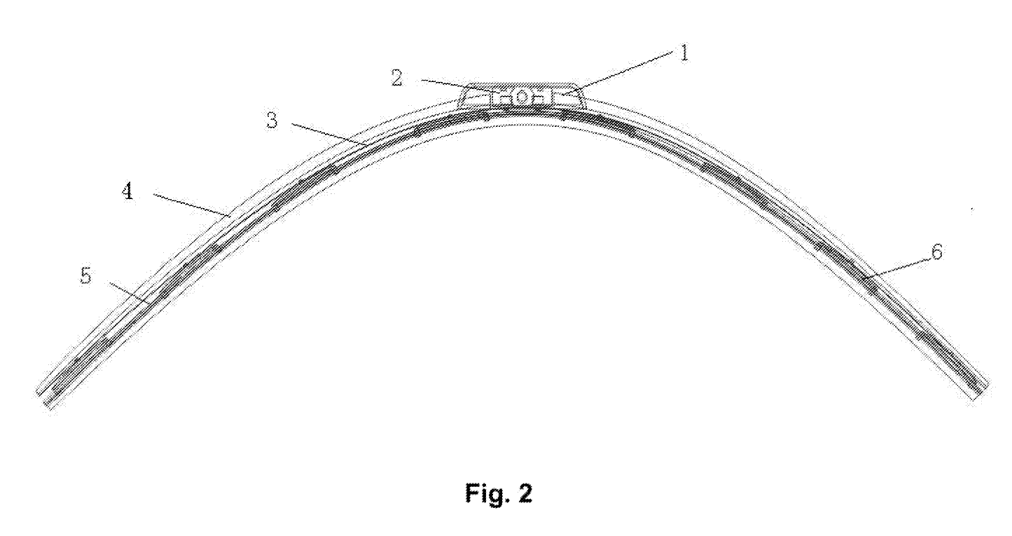

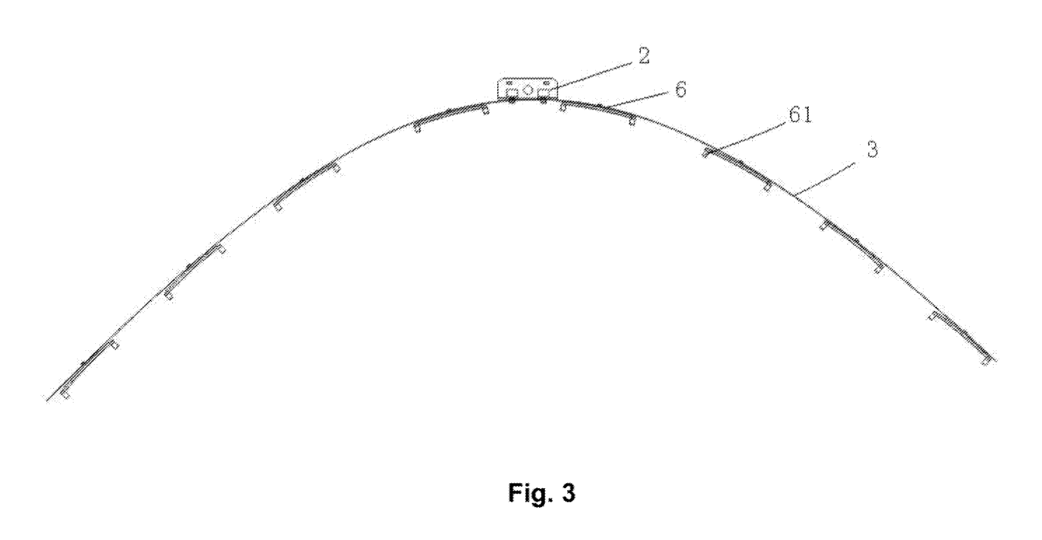

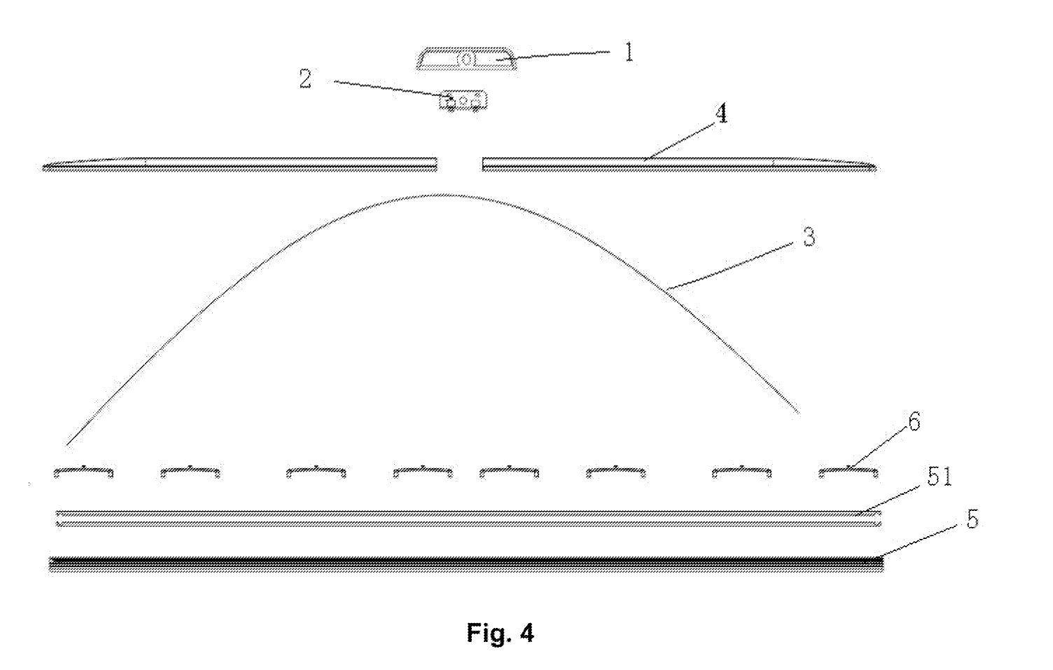

Refer to FIG. 2 to FIG. 4, the present invention aims to provide a frameless wiper blade for bus, wherein the wiper blade is frameless. The wiper blade comprises a plastic lid 1 connected with the wiper arm, an iron brush head 2, an elastic steel slice 3 connected with the iron brush head 2 fixedly and a wiper strip 5 mounted on the elastic steel slice 3 fixedly through connection structure 6. In the wiper strip 5, there are stainless steel wires 51. The wiper blade further comprises a plastic lid 1, wherein the plastic lid 1 is wrapped and mounted on the surface of the iron brush head 2. Install the wiper strip on the elastic steel slice 3, and bring the plastic lid 1 and the iron brush head 2 through wiper arm and further bring the elastic steel slice 3 to swing to wipe water. The connection structure 6 comprises at least 8 small flaps, wherein the 8 small flaps are mounted on the elastic steel slice 3 fixedly, the small flaps have a wing angle, and the wiper strip is mounted on the wing angle of the 8 small flaps. The force of wiper strip can be more even when working through setting at least 8 small flaps to reach better wiping effectively.

The elastic steel slice 3 is circular arc shaped, which is made by forming process. The present frameless wiper blade lower the height of the whole wiper blade through setting the elastic steel slice as circular arc shaped, so that the wiper strip 5 can keep good wiping angle with the glass surface, normally 40-60 angle, further it will wipe water more cleaner. The elastic steel slice 3 is connected with the iron brush head 2 fixedly by riveting. The surface of the steel elastic surface is provided with a rubber back cover 4. The rubber back cover 4 can protect the elastic steel slice 3 better from rusting through setting.

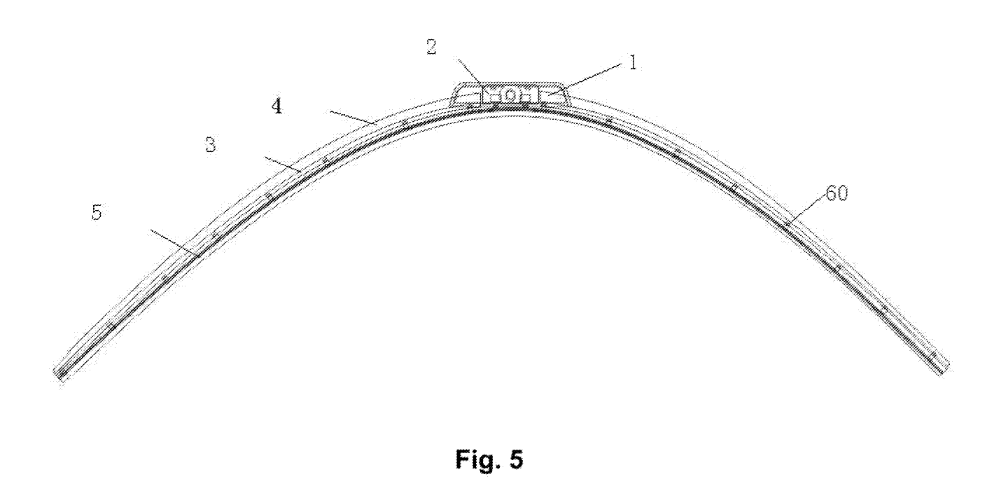

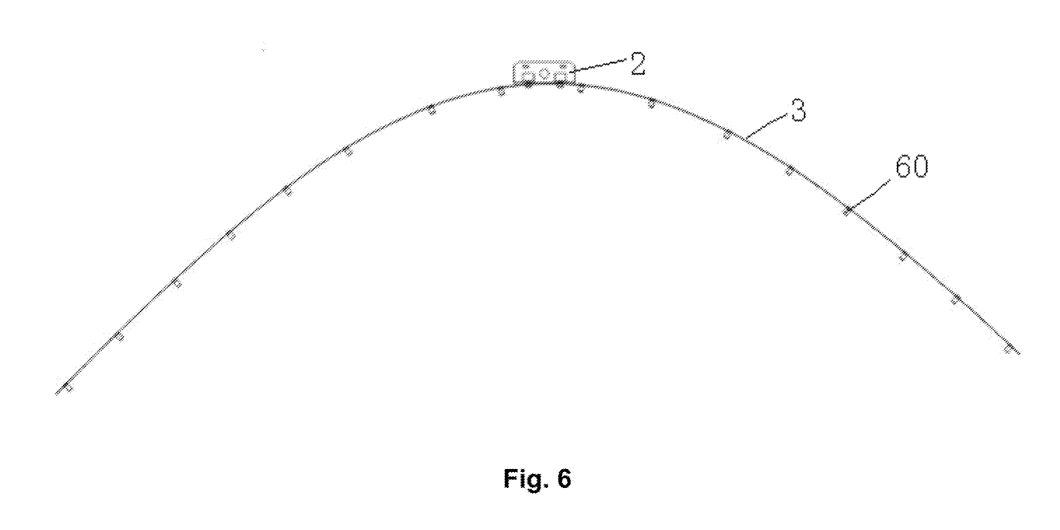

Refer to FIG. 5 and FIG. 6, in an alternative mode, the connection structure 6 includes at least 8 fasteners 60. and the fasteners 60 are mounted on the elastic steel slice 3, the wiper strip 5 is mounted on the fasteners 60. Preferably, the fasteners are hardware. In the wiper strip 5, there are stainless steel wires 51.

In conclusion and with reference to accompany drawings, the wiper strip 5 is mounted on the elastic steel slice 3, and the elastic steel slice 3 is mounted on the iron brush head 2, and the frameless wiper blade is realized by connecting the plastic lid 1 and iron brush head 2 with the wiper arm, which can reduce the weight of wiper blade for bus effectively in the prior art and reduce the workload of wiper blade motor to increase the lifetime. Further, the force of wiper strip 5 can be more even when working through setting at least 8 small flaps or 8 fasteners and flatten the elastic steel slice on the glass, thereby the wiper strip 5 can fit more closely with the windshield to wipe water cleaner. Moreover, compared with the prior art, the present frameless wiper blade abolish the whole iron frame and lower the height of the whole wiper blade through setting the elastic steel slice 3 as circular arc shaped, so that the wiper strip can keep good wiping angle with the glass surface to wipe water cleaner.

Need to explain, the drawings of the present invention are not based on the relative dimension, compared with other relative scale, some dimension has been exaggerated for clearer description and easier understanding, and for the simple drawing, the relative details are not drawn out.

The above are preferred modes of the present invention, and it should be pointed out that any variations that may come into the mind of those skilled in the art without breaking the principle of the present invention shall fall into the protection scope of the present invention.

I claim:

1. A frameless wiper blade, characterized in that the wiper blade comprises a plastic lid and an iron brush head connected with the wiper arm, an elastic steel slice connected with the iron brush head fixedly and the wiper strip mounted on the elastic steel slice fixedly through connection structure;

2. A frameless wiper blade according to claim 1, characterized in that the connection structure includes at least 8 small flaps, and the 8 small flaps are mounted on the elastic steel slice fixedly, and the wiper strip is mounted on the 8 small flaps.

3. A frameless wiper blade according to claim 2, characterized in that the elastic steel slice is circular arc shaped.

4. A frameless wiper blade according to claim 1, characterized in that the plastic lid is wrapped and mounted on the surface of the iron brush head.

5. A frameless wiper blade according to claim 1, characterized in that the elastic steel slice is connected with the iron brush head fixedly by riveting.

6. A frameless wiper blade according to claim 5, characterized in that the surface of the steel elastic surface is provided with a rubber back cover.

7. A frameless wiper blade according to claim 1, characterized in that the connection structure includes at least 16 fasteners, and the fasteners are mounted on the elastic steel slice, the wiper strip is mounted on the fasteners.
